(19) United States
(12) Patent Application Publication
(10) Pub. No.: US 2013/0139008 A1
(43) Pub. Date: May 30, 2013

(54) METHODS AND APPARATUS FOR ECC MEMORY ERROR INJECTION

(71) Applicants: Vydhyanathan Kalyanasundharam, San Jose, CA (US); Dean A. Liberty, Nashua, NH (US)

(72) Inventors: Vydhyanathan Kalyanasundharam, San Jose, CA (US); Dean A. Liberty, Nashua, NH (US)

(73) Assignee: ADVANCED MICRO DEVICES, INC., Sunnyvale, CA (US)

(21) Appl. No.: 13/306,651

(22) Filed: Nov. 29, 2011

(51) Int. Cl. G06F 11/00

(52) U.S. Cl. 714/703; 714/E11.02

(57) ABSTRACT

An error injection module for injecting errors into an ECC memory selects a target address associated with the ECC memory, selects an error injection pattern, and sets a redirect address of the scrubber to the target address. During an injection mode of the scrubber, the error injection module injects the error injection pattern into the target address of the ECC memory with the scrubber.

### TECHNICAL FIELD

Embodiments of the subject matter described herein relate generally to memory devices. More particularly, embodiments of the subject matter relate to error injection in error-correcting code (ECC) memory devices.

### BACKGROUND

A central processing unit (CPU) typically includes and/or cooperates with one or more memories, such as system dynamic random access memory (DRAM), multiple cache memories, and the like. Such memories often incorporate an error-correcting code (ECC) scheme to assist in locating and, if possible, fixing errors in individual memory bits. While ECC schemes are advantageous in many respects, they are accompanied by the need for extra testing. That is, ECC systems are typically tested by injecting errors into a running system memory to mimic random errors and subsequently determining whether such errors were corrected in accordance with the associated ECC code.

There are a variety of known ECC schemes. For example, it is possible to inject correctable (e.g., one-bit) errors during some predetermined number of writes, and then allow the errors to be corrected when data is read. In traditional ECC schemes, however, it is often difficult or impossible to specify the exact address that is subjected to the injected error. That is, there may be a lack of information regarding the particular cacheline location and bits used for error injection.

Accordingly, there is a need for improved methods for injecting and correcting errors in ECC memories.

### BRIEF SUMMARY OF EMBODIMENTS

A method of operating a scrubber for injecting errors into an ECC memory in accordance with one embodiment includes selecting a target address associated with the ECC memory, selecting an error injection pattern, and setting a redirect address of the scrubber to the target address. The method further includes injecting the error injection pattern into the target address of the ECC memory with the scrubber during operation in an injection mode.

A system for injecting errors into ECC memory in accordance with one embodiment includes a scrubber and a memory controller. The scrubber, the ECC memory, and the memory controller are communicatively coupled. The error injection module is configured to store a first field corresponding to a selected cacheline quadrant of a selected cacheline of the ECC memory, store a second field associated with a selected word of the selected cacheline quadrant, store a third field associated with an error injection pattern, and inject the error injection pattern into the selected word of the ECC memory in response to an injection request from the memory controller.

A memory scrubber system for an ECC memory in accordance with one embodiment includes a scrubber having a normal mode and an injection mode, and an error injection module communicatively coupled to the scrubber. The error injection module comprises a first register field corresponding to a selected cacheline quadrant of a selected cacheline of the ECC memory, a second register field associated with a selected word of the selected cacheline quadrant, and a third register field associated with a bit pattern. During the normal mode, the bit pattern corresponds to a corrected bit pattern, and the scrubber is configured to correct an error in the selected word of the ECC memory. During the injection mode, the bit pattern corresponds to an error injection pattern, and the error injection module is configured to instruct the scrubber to inject the error injection pattern into the selected word of the ECC memory.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram representation of an exemplary embodiment of a processor system;

FIG. 2 is a schematic block diagram representation of an exemplary memory structure useful in describing an exemplary embodiment; and

FIG. 3 is a flow chart that illustrates an exemplary embodiment of an error injection method.

### DETAILED DESCRIPTION

Embodiments of the subject matter disclosed herein generally relate to a memory scrubber system adapted to intentionally inject errors into a selected address of an ECC memory in addition to performing conventional redirect operations aimed at fixing previously detected errors. In this way, the ECC system can be more thoroughly and efficiently tested.

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, logic elements, look-up tables, or the like, which may carry out a variety of functions under the control of one or more microprocessors or other control devices.

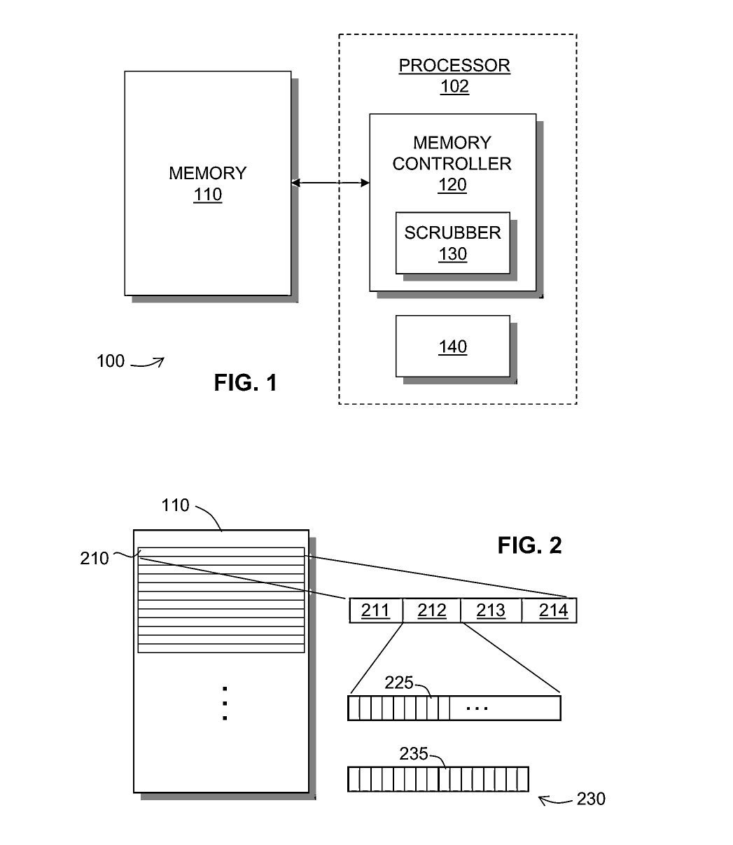

Referring now to the drawings, FIG. 1 is a schematic block diagram representation of an exemplary embodiment of a processor system 100. In this regard, FIG. 1 depicts a relatively simplified rendition of a processor system, including a processor 102, at least one memory module (or simply “memory”) 110 coupled to processor 102, a memory controller 120, a memory scrubber (or simply “scrubber”) 130, and an error injection code module (or simply “module”) 140. For the purposes of simplicity, other common modules and sub-modules, such as one or more prefetchers, one or more cache memories (e.g., a cache hierarchy comprising an L1 cache, L2 cache, etc.), an execution core, and the like are not illustrated in FIG. 1. Further, while module 140 is illustrated as separate from memory controller 120, in various embodiments module 140 may be incorporated into memory controller 120 or scrubber 130.

In general, memory controller 120 provides an interface between processor 102 and memory 110, which may include one or more individual memory banks, as is known in the art. As described in further detail below, memory 110 is preferably a type of error-correcting code (ECC) memory, and module 140 is configured to instruct scrubber 130 of memory controller 120 to carry out various error injection procedures to allow testing of those error-injection procedures as applied to memory 110.

Referring now to FIG. 2 in conjunction with FIG. 1, memory 110 is generally partitioned into what is conventionally referred to as a plurality of “cachelines” 210. That is, while memory 110 itself is not itself a part of the cache hierarchy, to the extent that most memory operations are performed in increments determined by the cachelines within the cache, memory 110 can be said to comprise a plurality of cachelines of a given size (e.g., 32 byte, 64 byte, etc.).

Each cacheline 210 of memory 110 may be further subdivided, for example, into cacheline quadrants 211-214, each being a fourth the size of a cacheline 210. In one embodiment, for example, each cacheline 210 of memory 110 comprises 64 bytes, and is subdivided into four 16-byte quadrants 211, 212, 213, and 214. In other embodiments, a greater or lesser number of cacheline subdivisions may be implemented. Each cacheline quadrant 211-214 comprises a number of bits 225 that themselves compose a number of words whose size may vary depending upon the embodiment. In one embodiment, for example, each cacheline quadrant 211-214 comprises a number of individually selectable 16-bit words.

As mentioned above, memory 110 is preferably an ECC memory component—i.e., a type of memory that is capable of detecting and correcting certain types of internal data errors, such as correctable one-bit errors. Such errors are generated, for example, by alpha particles, background radiation, or the like. The nature of ECC memories (and in particular DRAM ECC memories) is well known in the art, and need not be described in detail herein.

In the illustrated embodiment, each cacheline quadrant 211-214 is protected by a corresponding ECC word 230, which itself comprises a plurality of bits 235. ECC word 230 is suitably stored within memory 110 or in another memory module (not illustrated). In one embodiment, for example, each cacheline quadrant 211-214 stores a plurality of data words (e.g., 16-bit words) along with a corresponding ECC word 230 associated with those data words. In one embodiment, ECC word 230 is stored in bits [15:0] of a given cacheline 210.

Scrubber 130 includes any combination of hardware and/or software configured to inject one or more errors (e.g., by changing the state of one or more bits) into memory 110 and to carry out various additional functions as detailed below. In one embodiment, scrubber 130 is configured to operate in two modes, which may be referred to as a normal mode and an injection mode. The normal mode corresponds to a conventional scrubber operation in which scrubber 130 attempts to correct an error that had been previously detected (e.g., by accessing data within memory 110 and comparing that data using an ECC word 230) and to sequentially scrub memory 110. The injection mode, however, corresponds to an operation in which scrubber 130 working in conjunction with module 140 and memory controller 120 intentionally injects an error into memory 110 to thereby create a discrepancy between the stored data and the stored ECC word 230. As described in further detail below, the injection mode may make use of various target address fields and error injection fields to accomplish this task.

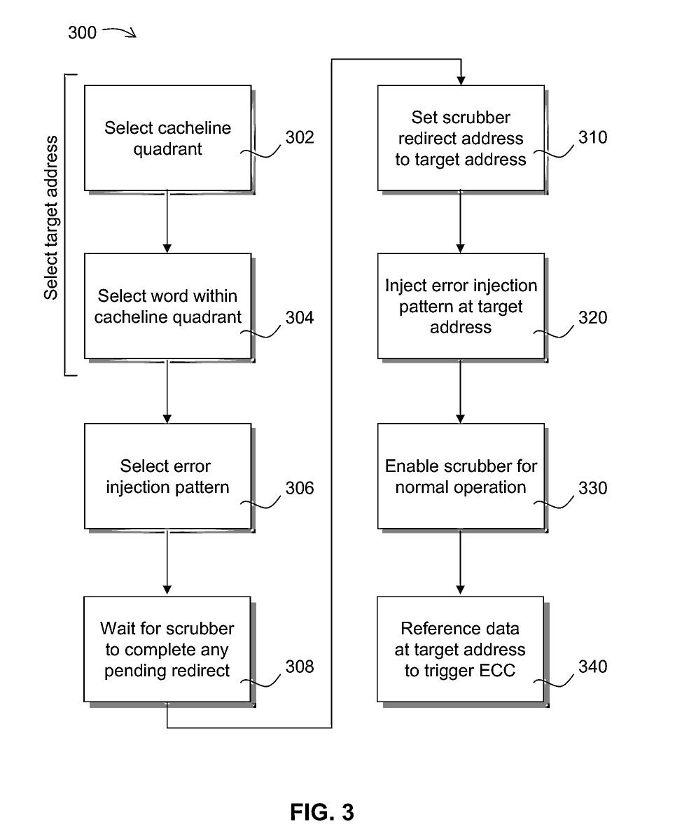

Having thus given an overview of an exemplary processor system 100 and memory 110, methods in accordance with various embodiments will now be described in conjunction with FIGS. 1-3. Specifically, FIG. 3 is a flow chart that illustrates an exemplary embodiment of an error injection process 300 suitably performed by module 140 in conjunction with memory controller 120, scrubber 130, and memory 110. In this regard, the various tasks performed in connection with a process described herein may be performed by software, hardware, firmware, or any combination thereof. For illustrative purposes, the description of a process may refer to elements mentioned above in connection with FIG. 1 and FIG. 2. In practice, portions of a described process may be performed by different elements of the described system. It should be appreciated that a described process may include any number of additional or alternative tasks, the tasks shown in the figures need not be performed in the illustrated order, and that a described process may be incorporated into a more comprehensive procedure or process having additional functionality not described in detail herein. Moreover, one or more of the tasks shown in the figures could be omitted from an embodiment of a described process as long as the intended overall functionality remains intact.

For ease of description and clarity, the illustrated method assumes that process 300 begins by selecting a given cacheline quadrant of memory 110. In general, however, process 300 will generally be performed sequentially for each cacheline 210 in memory 200. Thus, method 300 begins by selecting a target address associated with memory 110 by selecting a cacheline quadrant (e.g., one of quadrants 211-214) of a particular cache-line 210 (step 302) as well as a selected word within that quadrant (step 304). These values may be stored in corresponding fields (e.g., memory locations) within module 140. The size of these fields will vary depending upon the size of cachelines 210, the size of each word, and other such factors. More than one word within a given quadrant may be selected for error injection. Furthermore, the target address may be stored in any number of fields and in any suitable format. That is, the use of one field for designating a cacheline quadrant, and a second field for designating a particular word in that quadrant, is not intended to be limiting.

Next, in step 306, an error injection pattern is selected. That is, a particular series of bits (composing a “mask”) is produced in order to specify which bits 225 within the selected target address are to be corrupted. For example, the error injection pattern “0000000000000001” might be used to specify that the least significant bit within a 16-bit word should be inverted. In many cases, a single bit will intentionally be corrupted. In some embodiments, however, more than one bit may be corrupted. The selection of individual bits to be corrupted may be based, for example, on the ECC scheme being used as well as the word size. Corrupting more than two words may exceed the ability of a particular ECC scheme to detect the resulting errors. In one embodiment, no more than two symbols are corrupted in a single cacheline quadrant.

After selecting the target address and error injection pattern, the system waits for scrubber 130 to complete any pending redirect task (step 308) that might have been requested during the normal mode. That is, as mentioned briefly above, scrubber 130 preferably operates in accordance with a normal mode in which it performs standard scrubber redirect tasks (i.e., fixing an error), as well as an injection mode in which errors are intentionally injected. In one embodiment, the system sets a flag (e.g., one bit) in scrubber 130 requesting that the scrubber switch from the normal mode to the injection mode, and then waits for scrubber 130 to set a second flag (or the same flag) to indicate that the scrubber has completed the pending operation.

Next, in step 310, scrubber 130 enters the injection mode and first sets the redirect address of scrubber 130 to the target address (i.e., the cacheline quadrant and word selected in steps 302 and 304). The redirect address corresponds to the address that scrubber 130 would typically use during a redirect operation in its normal mode to correct a particular error.

After the target address and error injection pattern have been selected, scrubber 130 is instructed to inject the selected error injection pattern at the selected target address in memory 110, thereby causing an error to be introduced (step 320).

Next, in step 330, scrubber 130 is enabled for conventional operation. That is, scrubber 130 is once again placed in normal mode through any desired means (e.g., by setting a particular flag). After which, in step 340, the system suitably references the data at the target address, thereby triggering the ECC system within memory controller 120. In this way, the efficacy of the error injection scheme can be effectively tested using functionality already present in the form of scrubber 130.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of operating a scrubber for injecting errors into an error-correcting code (ECC) memory, the method comprising:
selecting a target address associated with the ECC memory;
selecting an error injection pattern;
setting a redirect address of the scrubber to the target address associated with the ECC memory; and
injecting the error injection pattern into the target address of the ECC memory with the scrubber.

2. The method of claim 1, wherein selecting the target address within the ECC memory includes selecting a cacheline quadrant of the ECC memory and selecting a word within the cacheline quadrant.

3. The method of claim 1, further including waiting for the scrubber to complete a pending redirect operation prior to injecting the error injection pattern during an injection mode.

4. The method of claim 3, wherein waiting for the scrubber to complete a pending redirect operation includes setting a first flag requesting that the scrubber switch from a normal mode to the injection mode, and waiting for the scrubber to set a second flag indicating that the scrubber has completed the pending redirect operation.

5. The method of claim 4, further including setting the scrubber in the normal mode after injecting the error injection pattern.

6. The method of claim 5, further including referencing the target address after injecting the error injection pattern.

7. The method of claim 1, wherein the ECC memory is a dynamic random access memory.

8. A system for injecting errors into an error-correcting code (ECC) memory, comprising:
a memory scrubber communicatively coupled to the ECC memory; and
an error injection module communicatively coupled to the memory scrubber;
wherein the error injection module is configured to store a first field associated with a selected word of a selected portion of a cacheline of the ECC memory, store a second field associated with an error injection pattern, and instruct the memory scrubber to inject the error injection pattern into the selected word of the ECC memory.

9. The system of claim 8, further wherein the error injection module is further configured to allow the memory scrubber to complete a pending redirect operation prior to injecting the error injection pattern.

10. The system of claim 9, wherein the error injection module is further configured to set a first flag requesting that the scrubber switch from a normal mode to the injection mode, and waiting for the scrubber to set a second flag indicating that the scrubber has completed the pending redirect operation.

11. The system of claim 8, wherein the ECC memory is a dynamic random access memory.

12. The system of claim 8, wherein the memory scrubber is configured to reference data in the target address after the error injection module injects the error injection pattern.

13. The system of claim 8, wherein the selected portion of the cacheline comprises a cacheline quadrant.

14. A memory scrubber system for an error-correcting code (ECC) memory, the memory scrubber system comprising:
a scrubber having a normal mode and an injection mode;
an error injection module communicatively coupled to the scrubber, the error injection module comprising:
a second register field associated with a selected word of a selected portion of a cacheline of the ECC memory; and
a third register field associated with a bit pattern;
wherein, during the normal mode, the bit pattern corresponds to a corrected bit pattern, and the scrubber is configured to correct the selected word of the ECC memory; and
wherein, during the injection mode, the bit pattern corresponds to an error injection pattern, and the error injection module is configured to instruct the scrubber to inject the error injection pattern into the selected word of the ECC memory.

15. The memory scrubber system of claim 14, wherein the memory scrubber is further configured to switch from the normal mode to the injection mode in response to an injection request from the error injection module.

16. The memory scrubber system of claim 14, wherein waiting for the scrubber to complete a pending redirect operation includes setting a first flag in the scrubber requesting that the scrubber switch from the normal mode to the injection mode, and waiting for the scrubber to set a second flag indicating that the scrubber has completed the pending redirect operation.

17. The memory scrubber system of claim 14, wherein the error injection module is further configured to set the scrubber to the normal mode after injecting the error injection pattern.

18. The memory scrubber system of claim 14, wherein the memory scrubber system is configured to reference data in the target address after injecting the error injection pattern.

19. The memory scrubber system of claim 14, wherein the portion of the selected cacheline comprises a cacheline quadrant.

20. The memory scrubber system of claim 14, wherein the ECC memory is a dynamic random access memory.
